(19) United States
(12) Patent Application Publication
(10) Pub. No.: US 2010/0130642 A1
(43) Pub. Date: May 27, 2010

(54) LACQUERS CONTAINING PARTICLES WITH PROTECTED ISOCYANATE GROUPS

(75) Inventors: Volker Stanjek, Munich (DE); Felicitas Schauer, Aying (DE); Juergen Pfeiffer, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 11/816,017

(22) PCT Filed: Feb. 7, 2006
(86) PCT No.: PCT/EP06/01058

§ 371 Date: Aug. 10, 2007

(30) Foreign Application Priority Data
Feb. 10, 2005 (DE) 10 2005 006 130.3
Jun. 9, 2005 (DE) 10 2005 026 700.9

(51) Int. Cl. C08K 9/06

(52) U.S. Cl. 523/212

(57) ABSTRACT

Particles obtained by silylating particles of a metal oxide or silicon oxide SOl with a silane containing at least one blocked isocyanate group are easily incorporated into coating materials such as clearcoats and topcoats, and imbue these coatings with high scratch resistance even at low filler content.

The invention relates to coating formulations, more particularly topcoat and clearcoat materials, which comprise particles which on their surface have protected isocyanate groups.

Coating systems comprising particles—more particularly nanoparticles—are state of the art. Such coatings are described for example in EP 1 249 470, WO 03/16370, US 20030194550 or US 20030162015. The particles in these coatings lead to an improvement in the properties of the coatings, more particularly with regard to their scratch resistance and also, possibly, their chemical resistance.

A frequently occurring problem associated with the use of the—generally inorganic—particles in organic coating systems consists in a usually inadequate compatibility between particle and coating-material matrix. This can lead to the particles being insufficiently dispersible in a coating-material matrix. Moreover, even well-dispersed particles may undergo settling in the course of prolonged standing or storage times, with the formation, possibly, of larger aggregates or agglomerates, which even on redispersion are impossible or difficult to separate into the original particles. The processing of such inhomogeneous systems is extremely difficult in any case, and in fact is often impossible. Coating materials which, once applied and cured, possess smooth surfaces are generally preparable by this route not at all or only at great cost.

Favorable, therefore, is the use of particles which on their surface possess organic groups that lead to improved compatibility with the coating-material matrix. In this way the inorganic particle becomes “masked” by an organic shell. Particularly favorable coating-material properties can be achieved in this context if, furthermore, the organic functions on the particle surfaces also possess groups that are reactive toward the coating-material matrix, so that under the respective curing conditions of the coating material in question they are able to react with the matrix. In this way, success is achieved in incorporating the particles into the matrix chemically in the course of coating-material curing, which often results in particularly good mechanical properties but also in improved chemical resistance. Systems of this kind are described for example in DE 102 47 359 A1, EP 832 947 A or EP 0 872 500 A1. A disadvantage of the systems described therein is the generally relatively high fractions of the comparatively expensive nanoparticles as a proportion of the total solids content of the coating material.

Also known, furthermore, is the use of coatings comprising a binder which has been modified with nanoparticles. These coatings can be produced by reacting the particles, equipped with a reactive functionality, with a binder containing a complementary function. In this case, therefore, the organofunctional particle is incorporated chemically into the coating-material matrix not only at the coating-material curing stage but in fact even at the binder preparation stage. Systems of this kind are described for example in EP 1 187 885 A or WO 01/05897. They possess, however, the disadvantage of being relatively costly and inconvenient to prepare, resulting in high preparation costs.

In the case of one particularly important type of coating material, a film-forming resin is used which comprises hydroxy-functional prepolymers which, on curing of the coating material, are reacted with an isocyanate-functional curative. These polyurethane coating materials are notable for particularly good properties, such as a superior chemical resistance, for example, yet there is still a need for improvement in particular as regards the scratch resistance of these systems. Typically they are used in particularly high-value and demanding fields of application: for example, as clearcoat and/or topcoat materials for OEM paint systems in the automobile and vehicle industry. The majority of topcoat materials for automobile repairs are also composed of isocyanate-curing systems of this kind.

Typically a distinction is made between two different polyurethane coating systems, known as 2K and 1K systems. The former consist of two components, one of which is composed essentially of the isocyanate curative, while the film-forming resin with its isocyanate-reactive groups is contained in the second component. The two components must be stored and transported separately and should not be mixed until shortly before they are processed, since the potlife of the completed mixture is greatly limited. Often more favorable, therefore, are the so-called 1K systems, composed of just one component, in which alongside the film-forming resin there is a curative containing protected isocyanate groups. 1K coating materials are cured thermally, the protective groups of the isocyanate units being eliminated, with the deprotected isocyanates being able then to react with the film-forming resin. Typical baking temperatures of such 1K coating materials are situated at 120-160° C.

In the case of these high-value coating materials in particular a further improvement in properties would be desirable. This is true in particular of vehicle finishes. For instance, the achievable scratch resistance of conventional auto finishes, in particular, is still not sufficient, with the consequence, for example, that particles in the washwater in a carwash lead to significant marring of the finish. Over time, this causes lasting damage to the gloss of the finish. In this situation, formulations that allow better scratch resistances to be achieved would be desirable.

One particularly advantageous way of achieving this objective is to use particles having protected isocyanate functions on their surface. Where such particles are incorporated into 1K polyurethane coating materials, the isocyanate functions on the particle surfaces are liberated as well in the course of coating-material curing, and the particle is incorporated chemically into the finish. Moreover, the protected isocyanate functions enhance compatibility between particle and coating-material matrix.

Particles of this kind containing protected isocyanate functions are in principle already known. Typically they are prepared by condensing particles having free silicon or metal hydroxide functions with alkoxysilyl-functional organosilicon compounds whose organic radical contains protected isocyanate functions. Organosilicon compounds of this kind containing masked isocyanate groups have already been described, as in DE 34 24 534 A1, EP 0 212 058 B1, JP 08-291186 or JP 10-067787, for example. The particles containing protected isocyanate functions themselves, and their use in coatings, are described in EP 0 872 500 A.

The scratch resistance of coating materials can in fact be increased significantly through the incorporation of such particles. However, in all of the methods of using these particles that have been described in the prior art, optimum results have still not been achieved. In particular the systems described in EP 0 872 500 A have such high particle contents that it would be very difficult to realize the use of such coating materials in large-scale production-line finishes, simply on grounds of cost.

It was an object of the invention, therefore, to develop a coating system that overcomes the disadvantages corresponding to the state of the art.

The invention provides coating formulations (B) comprising
a) 20-90% by weight, based on the solids fraction, of a film-forming resin (L) containing reactive groups,
b) 1-90% by weight, based on the solids fraction, of a coating curative (H) possessing reactive functions with which, for coating-material curing, it reacts on thermal treatment with the reactive groups of the film-forming resin (L),
c) 0.1-15% by weight, based on the solids fraction, of particles (P) which possess on their surface at least one protected isocyanate group which on thermal treatment eliminates a protective group to release an isocyanate function,
   the particles (P) being obtainable by a reaction of colloidal metal or silicon oxide sols with organosilanes (A) which possess a silyl function reactive toward the colloidal metal or silicon oxide sols and possess a protected isocyanate function,
d) 0-90% by weight, based on the overall coating formulation (B), of a solvent or a solvent mixture, and
e) if desired, further coating components and additives.

The solids fraction here encompasses those components of the coating material which, when the latter is cured, remain within the coating material.

The invention is based on the finding that, when the particles (P) are employed in coating systems, the change in the scratch resistance of the resulting coating materials is not proportional to the concentration of particles employed. On the contrary, even the small or very small amounts of particles (P) described are sufficient to produce a marked improvement in the scratch resistance of clearcoat materials, whereas no further significant increase in scratch resistance can be achieved even by means of higher fractions—in some cases much higher—of particles (P).

The small amounts of the relatively expensive particles (P) on the one hand allow the comparatively inexpensive preparation of highly scratch-resistant coatings, and on the other hand the low particle contents alleviate the—possibly negative—effect of the particles on other film properties, such as the elasticity or transparency and surface smoothness of the coating, for example. Accordingly the low particle contents represent a great advantage over the prior art.

In one preferred version of the invention the coating formulations (B) comprise hydroxyl-functional film-forming resins (L).

Preference is further given to coating formulations (B) whose coating curative (H) comprises a melamine-formaldehyde resin. Particular preference, however, is given to coating formulations (B) which comprise a coating curative (H) which, like the particles (P) as well, possesses protected isocyanate groups which on thermal treatment eliminate a protective group to release an isocyanate function.

The particles (P) are preferably obtainable through a reaction of colloidal metal or silicon oxide sols with organosilanes (A) of the general formula (I)

(R¹O)₃₋ₙ(R²)ₙSi-A-NH—C(O)—X (I)

where
R¹ denotes hydrogen, alkyl radical, cycloalkyl radical or aryl radical having in each case 1 to 6 C atoms, it being possible for the carbon chain to be interrupted by nonadjacent oxygen, sulfur or NR³ groups,
R² denotes alkyl radical, cycloalkyl radical, aryl radical or arylalkyl radical having in each case 1 to 12 C atoms, it being possible for the carbon chain to be interrupted by nonadjacent oxygen, sulfur or NR³ groups,
R³ denotes hydrogen, alkyl radical, cycloalkyl radical, aryl radical, arylalkyl radical, aminoalkyl radical or aspartate ester radical,
X denotes a protective group which is eliminated at temperatures between 60 and 300° C. in the form of HX, and releases an isocyanate function in the process, and
A represents a divalent unsubstituted or substituted alkylene radical, cycloalkylene radical or arylene radical having 1-10 carbon atoms, and
n can adopt the values 0, 1 or 2.

The group R¹ in the general formula (I) is preferably methyl or ethyl radicals. The group R² is preferably methyl, ethyl, isopropyl or phenyl radicals. R³ has preferably not more than 10 carbon atoms, more particularly not more than 4 carbon atoms. A represents preferably a difunctional carbon chain which has 1-6 carbon atoms and which may where appropriate be substituted by halogen atoms and/or alkyl side chains. With particular preference A represents a (CH₂)₃ group or a CH₂ group.

The preferred elimination temperatures of the protective groups, more particularly HX, are 80 to 200° C., with particular preference 100 to 170° C. Protective groups HX used may be secondary or tertiary alcohols, such as isopropanol or tert-butanol, CH-acidic compounds such as diethyl malonate, acetylacetone, ethyl acetoacetate, oximes such as formaldoxime, acetaldoxime, butane oxime, cyclohexanone oxime, acetophenone oxime, benzophenone oxime or diethylene glyoxime, lactams, such as caprolactam, valerolactam, butyrolactam, phenols such as phenol, o-methylphenol, N-alkyl amides such as N-methylacetamide, imides such as phthalimide, secondary amines such as diisopropylamine, imidazole, 2-isopropylimidazole, pyrazole, 3,5-dimethylpyrazole, 1,2,4-triazole and 2,5-dimethyl-1,2,4-triazole, for example. Preference is given to using protective groups such as butane oxime, 3,5-dimethylpyrazole, caprolactam, diethyl malonate, dimethyl malonate, ethyl acetoacetate, diisopropylamine, pyrrolidone, 1,2,4-triazole, imidazole and 2-isopropylimidazole. Particular preference is given to using protective groups which allow a low baking temperature, such as diethyl malonate, dimethyl malonate, butane oxime, diisopropylamine, 3,5-dimethylpyrazole, and 2-isopropylimidazole, for example.

In one preferred embodiment of the invention more than 50%, preferably at least 70%, and with particular preference at least 90% of the protected isocyanate groups of the particles (P) in the coating formulations (B) have been provided with protective groups which have a lower elimination temperature than butane oxime. With particular preference the protective groups of all the protected isocyanate groups of the particles (P) in the coating formulation (B) have a lower elimination temperature than butane oxime.

Particular preference is given in this context to coating formulations (B) which comprise particles (P) at least 50%, preferably at least 70%, and with particular preference 90%, more preferably 100%, of whose protected isocyanate groups have been protected with diisopropylamine, 3,5-dimethylpyrazole or 2-isopropylimidazole.

In a further preferred embodiment of the invention a feature of the coating formulations (B) of the invention is that more than 50%, preferably at least 70%, and with particular preference at least 90% of the protected isocyanate groups of the particles (P) have been provided with protective groups which have a lower elimination temperature than at least 55%, preferably at least 70%, more preferably at least 90% of the protective groups of the protected isocyanate groups of the curative (H). Particular preference in this context is given to coating formulations wherein the protective groups of all the protected isocyanate groups of the particles (P) in the coating formulation (B) have a lower elimination temperature than all of the protective groups of the protected isocyanate groups of the curative (H).

The elimination temperature is defined as being that temperature which is at least necessary for at least 80% of the protective groups of the corresponding type to be eliminated within 30 minutes to release free isocyanate functions. This elimination temperature can be determined by means for example of thermogravimetric methods. In that case the elimination temperature of the isocyanate-protective groups on the particles (P) is measured not by measuring the particles (P) themselves but instead by measuring the silane precursor (A). In other words, the resulting elimination temperature is defined as the elimination temperature of the isocyanate-protective groups on the particles (P). This method is advantageous because the particles (P) are often difficult, if not impossible, to isolate and are stable only in the dissolved state.

The preparation of the particles (P) starts from colloidal silicon oxides or metal oxides which are generally present as a dispersion of the corresponding oxide particles of submicron size in an aqueous or nonaqueous solvent. The oxides used may include those of the metals aluminum, titanium, zirconium, tantalum, tungsten, hafnium, and tin. Preference is given to using colloidal silicon oxide. This is generally a dispersion of silicon dioxide particles in an aqueous or nonaqueous solvent, particular preference being given to organic solutions of colloidal silica sols. The silica sols are generally 1-50% strength solutions, preferably 20-40% strength solutions. Typical solvents, beside water, are alcohols in particular, especially alkanols having 1 to 6 carbon atoms—frequently isopropanol but also other alcohols, usually of low molecular mass, such as methanol, ethanol, n-propanol, n-butanol, isobutanol, and tert-butanol, for example, the average particle size of the silicon dioxide particles being 1-100 nm, preferably 5-50 nm, more preferably 8-30 nm.

The preparation of the particles (P) from colloidal silicon oxides or metal oxides may take place by a variety of processes. Preferably, though, it takes place by addition of the silanes (A) to the aqueous or organic sol. This sol is, where appropriate, stabilized acidically, such as by hydrochloric or trifluoroacetic acid, for example, or alkalinically, such as by ammonia, for example. The reaction takes place in general at temperatures of 0-200° C., preferably at 10-80° C., and with particular preference at 20-60° C. The reaction times are typically between 5 min and 48 h, preferably between 1 and 24 h. Optionally it is also possible to add acidic, basic or heavy metal catalysts. They are used preferably in amounts <1000 ppm. With particular preference, however, no separate catalysts are added.

Since colloidal silicon oxide or metal oxide sols are often in the form of an aqueous or alcoholic dispersion, it may be advantageous to exchange the solvent or solvents, during or after the preparation of the particles (P), for another solvent or for another solvent mixture. This can be done, for example, by distillatively removing the original solvent, it being possible to add the new solvent or solvent mixture in one step or else in a plurality of steps, before, during or else not until after the distillation. Suitable solvents in this context may be, for example, water, aromatic or aliphatic alcohols, in which case preference is given to aliphatic alcohols, more particularly aliphatic alcohols having 1 to 6 carbon atoms (e.g., methanol, ethanol, n-propanol, isopropanol, n-butanol, isobutanol, tert-butanol, the various regioisomers of pentanol and hexanol), esters (e.g., ethyl acetate, propyl acetate, butyl acetate, butyl diglycol acetate, methoxypropyl acetate), ketones (e.g., acetone, methyl ethyl ketone), ethers (e.g., diethyl ether, tert-butyl methyl ether, THF), aromatic solvents (toluene, the various regioisomers of xylene, and also mixtures such as solvent naphtha), lactones, (e.g., butyrolactone, etc.) or lactams (e.g., N-methylpyrrolidone). Preference is given here to aprotic solvents and solvent mixtures which are composed exclusively or else at least partly of aprotic solvents. Aprotic solvents have the advantage that any solvent residues at the coating-material curing stage are inert toward isocyanate functions after the elimination of the protective groups. Besides the preparation of a particle dispersion, the isolation of the particles in solid form is also preferable.

The reaction between the colloidal silicon oxide or metal oxide sols and the organosilanes (A) takes place preferably directly when the reactants are mixed. A particular advantage in this context is to use silanes (A) of the general formula (I) in which the spacer A stands for a CH₂ bridge, since a feature of these silanes (A) is a particularly high reactivity toward the hydroxyl groups of the metal oxide or silicon oxide particles, so that the functionalization of these particles with these silanes can be carried out particularly quickly and at low temperatures, more particularly even at room temperature. The colloidal metal oxides or silicon oxides may be functionalized in an aqueous or else anhydrous protic or aprotic solvent.

Where silanes (A) of the general formula (I) are used that only possess monoalkoxysilyl functions (i.e., silanes of the general formula (I) with n=2), there is no need to add water during the preparation of the particles (P), since the monoalkoxysilyl groups are able to react directly with the hydroxyl functions on the surface of the colloidal metal-oxide or silicon-oxide particles. If, on the other hand, silanes (A) with di- or trialkoxysilyl groups are used (i.e., silanes of the general formula (I) with n=0 or 1), then the addition of water during the preparation of the particles (P) is often advantageous, since in that case the alkoxysilanes are able to react not only with the hydroxyl groups of the colloidal metal oxides or silicon oxides but also—following their hydrolysis—with one another. This produces particles (P) which possess a shell composed of inter-crosslinked silanes (A).

In the preparation of the particles (P) it is possible to carry out the surface modification using not only the silanes (A) but also any desired mixtures of the silanes (A) with other silanes (S1), silazanes (S2) or siloxanes (S3). The silanes (Si) possess either hydroxysilyl groups or else hydrolyzable silyl functions, the latter being preferred. These silanes may additionally possess further organic functions, although silanes (S1) without further organic functions can also be used.

Particular preference is given to using mixtures of silanes (A) with silanes (S1) of the general formula (II)

(R¹⁰)_{4-a-b}(R²)ₐSiR⁴_{b} (II)

where
R¹, R² and R³ are as defined for the general formula (I), and
R⁴ radicals denote identical or different SiC-bonded hydrocarbon radicals having 1 to 18 carbon atoms, substituted if desired by halogen atoms, amino groups, ether groups, ester groups, epoxy groups, mercapto groups, cyano groups, isocyanate groups, methacrylic groups or (poly)glycol radicals, the latter being composed of oxyethylene and/or oxypropylene units,
a denotes 0, 1, 2 or 3, and
b denotes 0, 1, 2 or 3.

Here a is preferably 0, 1 or 2, while b is preferably 0 or 1.

Silazanes (S2) and/or siloxanes (S3) used are with particular preference hexamethyldisilazane and/or hexamethyldisiloxane.

In one preferred embodiment of the invention the coating formulations (B) comprise
a) 30-80% by weight, based on the solids fraction, of a film-forming resin (L),
b) 10-60% by weight, based on the solids fraction, of a coating curative (H),
c) 0.1-12% by weight, based on the solids fraction, of particles (P),
d) 0-80% by weight, based on the overall coating formulation (B), of a solvent or solvent mixture, and
e) if desired, further coating components and additives.

With particular preference the coating formulations (B) comprise
a) 40-70% by weight, based on the solids fraction, of a film-forming resin (L),
b) 15-50% by weight, based on the solids fraction, of a coating curative (H),
c) 0.1-10% by weight, based on the solids fraction, of particles (P),
d) 20-70% by weight, based on the overall coating formulation (B1) or (B2), of a solvent or solvent mixture, and
e) if desired, further coating components and additives.

With particular preference the fraction of the solvent or solvents as a proportion of the overall coating formulation (B) is 20% to 60% by weight.

The amount of particles (P) is preferably 0.2-10% by weight, based on the solids fraction, more preferably 0.3-8% by weight. In especially advantageous embodiments of the invention the amount of particles (P) is 0.5-5% by weight, based on the solids fraction, more particularly 0.8-3% by weight.

The film-forming resins (L) present alongside the particles (P) in the coating formulations (B) of the invention are preferably composed of hydroxyl-containing prepolymers, with particular preference of hydroxyl-containing polyacrylates or polyesters. Hydroxyl-containing polyacrylates and polyesters of this kind, suitable for coating-material preparation, are sufficiently well known to the skilled worker and have been described in numerous instances in the relevant literature.

Likewise sufficiently well known as state of the art, and described in numerous instances in the corresponding literature, are the coating curatives (H) present in the coatings (B) of the invention, preferably melamine-formaldehyde resins or contain protected isocyanate groups which on thermal treatment eliminate a protective group to release an isocyanate function. Particularly preferred among these are curatives (H) which contain protected isocyanate functions. Usually for this purpose use is made of common di- and/or polyisocyanates which have been provided beforehand with the respective protective groups. Suitable protective groups in this context are the same compounds described in connection with the general formula (I) and also in the paragraphs following the general formula (I) as protective groups HX, although the protective groups of the particles (P) and of the curative (H) must—in accordance with the provisions of the described preferred versions of the invention—be matched to one another. As isocyanates it is possible in principle to use all customary isocyanates, of the kind described in numerous instances in the literature. Common diisocyanates are, for example, diisocyanatodiphenylmethane (MDI), both in the form of crude or technical MDI and in the form of pure 4,4′ and/or 2,4′ isomers or mixtures thereof, tolylene diisocyanates (TDI) in the form of its various regioisomers, diisocyanatonaphthalene (NDI), isophorone diisocyanate (IPDI), perhydrogenated MDI (H-MDI), tetramethylene diisocyanate, 2-methylpentamethylene diisocyanate, 2,2,4-trimethylhexamethylene diisocyanate, dodecamethylene diisocyanate, 1,4-diisocyantocyclohexane, 1,3-diisocyanato-4-methylcyclohexane or else hexamethylene diisocyanate (HDI). Examples of polyisocyanates are polymeric MDI (P-MDI), triphenylmethane triisocyanate, and also all isocyanurate trimers or biuret trimers of the diisocyanates set out above. In addition it is also possible to use further oligomers of the above-mentioned isocyanates with blocked NCO groups. All di- and/or polyisocyanates can be used individually or else in mixtures. Preference is given to using the isocyanurate trimers and biuret trimers of the comparatively DV-stable aliphatic isocyanates, with particular preference to trimers of HDI and IPDI.

The ratio of the blocked isocyanate groups of the curative (H) and of the particles (P) with respect to the isocyanate-reactive groups of the film-forming resin (L) is typically chosen from 0.5 to 2, preferably from 0.8 to 1.5, and with particular preference from 1.0 to 1.2.

It is possible, furthermore, for the coating formulations (B) to further comprise the common solvents and also the coating-material components and additives that are typical in coating formulations. As solvents mention may be made, by way of example, of aromatic and aliphatic hydrocarbons, esters such as butyl acetate, butyl diglycol acetate, ethyl acetate or methoxypropyl acetate, ethers, alcohols such as isopropanol or isobutanol, ketones such as acetone or butyl methyl ketone, and heterocycles such as lactones or lactams. A further important solvent is water. Thus water-based coating materials are of heightened interest on account in particular of their low VOC fractions (volatile organic compounds). Additives here would include, among others, flow control assistants, surface-active substances, adhesion promoters, light stabilizers such as DV absorbers and/or free-radical scavengers, thixotropic agents, and other solids. To generate the profiles of properties that are desired in each case, both of the coating formulations (B) and of the cured coatings, adjuvants of this kind are generally indispensable. The coating formulations (B) may also include pigments.

In the case of one preferred process the coating formulations (B) of the invention are produced by adding the particles (P), during the mixing operation, in the form of a powder or a dispersion in a suitable solvent. In addition, however, a further process is preferred wherein to start with a masterbatch is produced from the particles (P) and from one or more coating-material components, the masterbatch having particle concentrations >15%, preferably >25%, and with particular preference >35%. In the context of the preparation of the coating formulations (B) of the invention, this masterbatch is then mixed with the other coating-material components. Where the masterbatch is prepared starting from a particle dispersion, it may be advantageous if the solvent of the particle dispersion is removed in the course of the preparation of the masterbatch, via a distillation step, for example, or else replaced by a different solvent or solvent mixture.

The resulting coating formulations (B) can be used to coat any desired substrates for the purpose of enhancing the scratch resistance, abrasion resistance or chemical resistance. Preferred substrates are plastics such as polycarbonate, polybutylene terephthalate, polymethyl methacrylate, polystyrene or polyvinyl chloride, and other coatings applied in a preceding step.

With particular preference the coating formulations (B) can be used as scratch-resistant clearcoat or topcoat materials, more particularly in the vehicle industry. The coating composition can be applied by any desired methods such as immersion, spraying and pouring methods. Also possible is application by a wet in wet process. Curing takes place by heating under the conditions necessary for blocked isocyanates, and can of course be accelerated through the addition of catalysts.

All of the symbols in the above formulae have their definitions in each case independently of one another. In all formulae the silicon atom is tetravalent.

Unless indicated otherwise, all quantity and percentage figures are based on the weight, all pressures are 0.10 MPa (abs.), and all temperatures are 20° C.

### EXAMPLES

### Synthesis Example 1

### Preparation of an Alkoxysilane with Diisopropylamine-Protected Isocyanate Groups (Silane 1)

86.0 g of diisopropylamine and 0.12 g of Borchi® catalyst (catalyst VP 0244 from Borchers GmbH) are initially taken and heated to 80° C. Over the course of 1 h 150.00 g of isocyanatomethyltrimethoxysilane are added dropwise and the mixture is stirred at 60° C. for 1 h. ¹H NMR and IR spectroscopy show that the isocyanatosilane has been fully reacted.

### Synthesis Example 2

### Preparation of an Alkoxysilane with Diisopropylamine-Protected Isocyanate Groups (Silane 2)

74.5 g of diisopropylamine and 0.12 g of Borchi® catalyst (catalyst VP 0244 from Borchers GmbH) are initially taken and heated to 80° C. Over the course of 1 h 150.00 g of 3-isocyanatopropyltrimethoxysilane are added dropwise and the mixture is stirred at 60° C. for 1 h. ¹H NMR and IR spectroscopy show that the isocyanatosilane has been fully reacted.

### Synthesis Example 3

### Preparation of SiO₂ Nanosol Particles Modified with Blocked Isocyanate Groups

1.40 g of the diisopropylamine-protected isocyanatosilane (silane 1) prepared in accordance with Synthesis Example 1 are dissolved in 1.0 g of isopropanol. Then, over the course of 30 min, 20 g of an SiO₂ organosol (IPA-ST from Nissan Chemicals, 30% by weight SiO₂, 12 nm average particle diameter) are added dropwise and the pH is adjusted to 3.5 by addition of trifluoroacetic acid. The dispersion obtained is stirred at 60° C. for 3 h and then at room temperature for 18 h. Thereafter 18.1 g of methoxypropyl acetate are added. The mixture is stirred for a few minutes and then a major fraction of the isopropanol is distilled off at 70° C. In other words, distillation is continued until the nanoparticle sol has been concentrated to 29.4 g. This gives a dispersion having a solids content of 25.5%. The SiO₂ content is 20.8%, and the amount of protected isocyanate groups in the dispersion is 0.17 mmol/g. The dispersion is slightly turbid and exhibits a Tyndall effect.

### Synthesis Example 4

### Preparation of SiO₂ Nanosol Particles Modified with Blocked Isocyanate Groups

1.54 g of the diisopropylamine-protected isocyanatosilane (silane 2) prepared in accordance with Synthesis Example 2 are initially taken. Then, over the course of 30 min, 20 g of an SiO₂ organosol (IPA-ST from Nissan Chemicals, 30% by weight SiO₂, 12 nm average particle diameter) are added dropwise and the pH is adjusted to 3.0 by addition of trifluoroacetic acid. The dispersion obtained is stirred at 60° C. for 3 h and then at room temperature for 24 h.

The resulting dispersion has a solids content (particle content) of 35%, the SiO₂ content is 27.9%, and the amount of protected isocyanate groups in the dispersion is 0.23 mmol/g. The dispersion is slightly turbid and exhibits a Tyndall effect.

### Examples 1-8

### Preparation of a One-Component Coating Formulation Comprising SiO₂ Nanosol Particles Modified with Blocked Isocyanate Groups

To produce a coating formulation of the invention, an acrylate-based paint polyol having a solids content of 52.4% by weight (solvents: solvent naphtha, methoxypropyl acetate (10:1)), a hydroxyl group content of 1.46 mmol/g resin solution, and an acid number of 10-15 mg KOH/g is mixed with Desmodur® BL 3175 SN from Bayer (butane oxime-blocked polyisocyanate, blocked NCO content of 2.64 mmol/g). The amounts used of the respective components can be taken from Table 1. Subsequently the amounts as per Table 1 of the dispersion prepared according to Synthesis Example 3 are added, attaining in each case a molar ratio of protected isocyanate functions to hydroxyl groups of 1.1:1. In addition, in each case 0.01 g of a dibutyltin dilaurate and 0.03 g of a 10% strength solution of ADDID® 100 from TEGO AG (flow control assistant based on polydimethylsiloxane) in isopropanol are mixed in, giving coating formulations with a solids content of approximately 50%. These mixtures, which initially are still slightly turbid, are stirred at room temperature for 48 h, giving clear coating formulations.

TABLE 1
Formulas of the coating materials (Example 1-9)

| | | | Nanosol as | Particle |
|---|---|---|---|---|
| | Desmophen ® | Desmodur ® | per Synth. | con- |
| | A 365 BA/X | BL 3175 SN | Ex. 3 | tent* |
| Example 1 | 4.50 g | 2.73 g | 0.0 g | 0.0% |
| (compara- | | | | |
| tive**) | | | | |
| Example 2 | 4.50 g | 2.72 g | 0.30 g | 1.7% |
| Example 3 | 4.50 g | 2.71 g | 0.38 g | 2.2% |
| Example 4 | 4.50 g | 2.70 g | 0.57 g | 3.2% |
| Example 5 | 4.50 g | 2.69 g | 0.76 g | 4.2% |
| Example 6 | 4.50 g | 2.64 g | 1.52 g | 8.2% |
| Example 7 | 4.50 g | 2.60 g | 2.11 g | 11.2% |
| Example 8 | 1.00 g | 0.49 g | 1.80 g | 34% |
| (compara- | | | | |
| tive**) | | | | |
| Example 9 | 0.88 g | 0.40 g | 2.05 g | 41% |
| (compara- | | | | |
| tive**) | | | | |

*Fraction of the particles as per Synthesis Example 3 as a proportion of the total solids content of the respective coating formulation
**Noninventive

### Example 10

### Preparation of a One-Component Coating Formulation Comprising SiO₂ Nanosol Particles Modified with Blocked Isocyanate Groups

To produce a coating of the invention, 4.50 g of an acrylate-based paint polyol having a solids content of 52.4% by weight (solvents: solvent naphtha, methoxypropyl acetate (10:1)), a hydroxyl group content of 1.46 mmol/g of resin solution, and an acid number of 10-15 mg KOH/g are mixed with 2.71 g of Desmodur® BL 3175 SN from Bayer (butane oxime-blocked polyisocyanate, blocked NCO content of 2.64 mmol/g). Subsequently 0.29 g of the dispersion prepared according to Synthesis Example 4 is added, containing SiO₂ nanosol particles which have been modified with diisopropylamine-blocked isocyanate groups. This corresponds to a molar ratio of protected isocyanate functions to hydroxyl groups of 1.1:1. The amount of particles as per Synthesis Example 4 as a proportion of the total solids content is 2.2%. In addition, 0.01 g of a dibutyltin dilaurate and 0.03 g of a 10% strength solution of ADDID® 100 from TEGO AG (flow control assistant based on polydimethylsiloxane) in isopropanol are mixed in, giving a coating formulation with a solids content of approximately 50%. This mixture, which initially is still slightly turbid, is stirred at room temperature for 48 h, giving a clear coating formulation.

Production and Evaluation of Coating Films from the Coating Formulations of Examples 1-10

The coating materials from Examples 1-9 are each knife-coated onto a glass plate, using a Coatmaster® 509 MC film-drawing device from Erichsen, with a knife having a slot height of 120 μm. The coating films obtained are then dried in a forced-air drying cabinet at 70° C. for 30 minutes and then at 150° C. for 30 minutes. Both from the coating formulations of the examples and also from the comparative examples, coatings are obtained which are visually flawless and smooth. The gloss of the coatings is determined using a Micro gloss 20° gloss meter from Byk, and is between 159 and 164 gloss units for all of the coating formulations.

The scratch resistance of the cured coating films thus produced is determined using a Peter-Dahn abrasion-testing instrument. For this purpose a Scotch Brite® 2297 abrasive nonwoven with an area of 45×45 mm is loaded with a weight of 500 g and used for scratching the coating samples with a total of 40 strokes. Both before the beginning and after the end of the scratch tests, the gloss of the respective coating is measured using a Micro gloss 20° gloss meter from Byk. As a measure of the scratch resistance of the respective coating, the loss of gloss in comparison to the initial value was ascertained:

TABLE 2
Loss of gloss in the Peter-Dahn scratch test

| Coating sample | Loss of gloss |
|---|---|
| Example 1 (comparative*) | 72% |
| Example 2 | 30% |
| Example 3 | 32% |
| Example 4 | 27% |
| Example 5 | 29% |
| Example 6 | 32% |
| Example 7 | 25% |
| Example 8 (comparative*) | 26% |
| Example 9 (comparative*) | 24% |
| Example 10 | 30% |

*noninventive

The results show that even very small amounts of the particles (P) of the invention lead to a marked increase in the scratch resistance of the corresponding coating. The coating formulations of the noninventive examples 7 and 8, which contain much higher particle contents—and hence are much more expensive—do not lead to coatings whose scratch resistances would be improved significantly in relation to the coatings of the invention.

1.-14. (canceled)

15. Coating formulations comprising
a) 20-90% by weight of at least one film-forming resin containing reactive groups,
b) 1-90% by weight of at least one coating curative possessing reactive functions react at elevated temperature with the reactive groups of the film-forming resin,
c) 0.1-15% by weight of particles which possess on their surface at least one protected isocyanate group which at elevated temperature eliminates a protective group to release an isocyanate function, the particles being obtained by reaction of colloidal metal oxide and/or silicon oxide sols with organosilanes which possess a silyl function reactive toward the colloidal metal oxide and/or silicon oxide sols and possess a protected isocyanate function, and
d) 0-90% by weight, based on the overall coating formulation, of a solvent or a solvent mixture,
wherein the percents by weight are relative to the solids fraction of the coating formulation.

16. The coating formulation of claim 15, wherein the hydroxyl-functional film-forming resins are hydroxyl-functional film-forming resins.

17. The coating formulation of claim 15, wherein the coating curative comprises a melamine-formaldehyde resin.

18. The coating formulation of claim 15, wherein the coating curative comprises protected isocyanate groups which eliminate a protective group to release an isocyanate function at elevated temperature.

19. The coating formulation of claim 15, wherein the particles are obtained by a reaction of colloidal metal oxide or silicon oxide sol(s) with organosilanes of the general formula (I)
(R¹O)₃₋ₙ(R²)ₙSi-A-NH—C(O)—X (I)
where
R′ each individually is hydrogen, or an alkyl, cycloalkyl or aryl radical having up to 6 C atoms, the carbon chain optionally interrupted by nonadjacent oxygen, sulfur or NR³ groups,
R² each individually is an alkyl, cycloalkyl, aryl or arylalkyl radical having up to 12 C atoms, the carbon chain optionally interrupted by nonadjacent oxygen, sulfur or NR³ groups,
R³ each individually is hydrogen, or an alkyl, cycloalkyl, aryl, arylalkyl, aminoalkyl or aspartate ester radical,
X is a protective group which is eliminated at temperatures of 60 to 300° C. in the form of HX, and releases an isocyanate function in the process, and
A is a divalent unsubstituted or substituted alkylene, cycloalkylene or arylene radical having 1-10 carbon atoms, and
n is 0, 1 or 2.

20. The coating formulation of claim 19, wherein n=2.

21. The coating formulation of claim 15, wherein the amount of particles in the formulation is 0.2 12% by weight, based on the solids fraction.

22. The coating formulation of claim 15, wherein the elimination temperatures of the protective groups are 80 to 200° C.

23. The coating formulation of claim 15, wherein more than 50% of the protected isocyanate groups of the particles have protective groups which have a lower elimination temperature than butane oxime.

24. The coating formulation of claim 15, wherein more than 50% of the protected isocyanate groups of the particles have protective groups which have a lower elimination temperature than at least 55% of the protected isocyanate groups of the curative.

25. A coating formulation of claim 15, comprising
a) 30-80% by weight of film-forming resin,
b) 10-60% by weight of the coating curative,
c) 0.1-12% by weight of said particles, and
d) 0-80% by weight, based on the overall coating formulation (B), of a solvent or solvent mixture.

26. The coating formulation of claim 15, wherein the film-forming resins (L) are hydroxyl-containing prepolymers.

27. The coating formulation of claim 15, further comprising at least one of flow control assistant(s), surface-active substances, adhesion promoters, light absorbers, free-radical scavengers, thixotropic agents, and fillers other than the protected isocyanate group-containing fillers c).

28. The coating formulation of claim 15, which is a clear coat or topcoat formulation.
